(19) United States
(12) Patent Application Publication
(10) Pub. No.: US 2020/0103540 A1
(43) Pub. Date: Apr. 2, 2020

(54) WELLS SEISMIC METHOD OF SPATIAL (3D) RESEARCHES

(71) Applicants: Alexey Gorbunov, Highlands Ranch, CO (US); Oleksandr Gorbunov, Kyiv (UA); Valeriy Ivanovich Gorbunov, Aurora, CO (US)

(72) Inventors: Alexey Gorbunov, Highlands Ranch, CO (US); Oleksandr Gorbunov, Kyiv (UA); Valeriy Ivanovich Gorbunov, Aurora, CO (US)

(21) Appl. No.: 16/147,798

(22) Filed: Sep. 30, 2018

(51) Int. Cl. G01V 1/137

(52) U.S. Cl. CPC G01V 1/137; G01V 2210/161

(57) ABSTRACT

The method is aimed at improving the accuracy and reliability of exploration and prospecting for minerals in a complex geological environment, as well as studying the dynamics of the active zones of the earth's crust.

Advantages:
Improved accuracy and reliability of geological forecasts, which results in more accurate design, development, and execution of the corresponding business projects.
Reduced risks of the damage to industrial infrastructure (existing oil field's equipment) compared to using the seismic vibration survey.
Expanded geophysical support range for production processes within the universal methodology of high-resolution seismic research.
Reduced cost relative to the traditional approach.

### CROSS-REFERENCE TO RELATED APPLICATION

This application is a continuation of U.S. provisional patent application
EFS ID 30530568
Application Number 62566378
Confirmation Number 1820
Title of Invention WELLS SEISMIC METHOD OF SPATIAL (3D) RESEARCHES
First Named Inventor Alexey Gorbunov
Customer Number or
Correspondence Address Alexey Gorbunov
   9667 Timbervale Ct.
   Highlands Ranch
   CO
   80129
   US
   7208080300
   Alexey.Gorbunov@3sgr.com
Filed By Alexey Gorbunov
Attorney Docket Number SSSGROU PLTD201706103DVSP
Filing Date
Receipt Date 30 Sep. 2017
Application Type Provisional

### BACKGROUND OF THE INVENTION

The present invention is in the exploration of the mineral fields. More particularly, the present invention is in the technical field of applied seismology. Specifically, the invention relates to 3D seismic in the wells.

Canadian inventor Reginald Fessenden offered the first invention with geophones location into the well in 1918. In 1931 B. McCollum and W. W. Larue proposed that local geologic structure could be determined by measuring the arrival of seismic energy from surface sources with immersed receivers [1]. The VSP as a seismic technology was initially developed in the Soviet Union in the 1960s by E. Galperin [2]. It was only later, in the mid-1970s, that non-Soviet geophysicists became systematically engaged in advance of VSP technology for exploration applications [3]. The greatest success in the theory and practice of the GSP achieved by Schlumberger Company [http://www.slb.com/services/seismic/borehole_seis.aspx]. Now, borehole seismic surveys provide much more than kinematic measurements, speed analysis and compliance of the seismic sections time scale to the depth scale of logging data. Modern well seismic surveying solves the problems of constructing three-dimensional times and depth images of the geological environment, predicting the properties of geological formations, the conditions of drilling wells, as well as forecasting their operation modes. [4-5].

Over the past decades, research in the field of VSP has been carried out in two main directions. 1) Improvement of well logging equipment for recording seismic signals and the methodological of their use. 2) Software application development for vertical seismic profiling data processing.

In the industrial application remained a scheme with the location of the source of oscillations on the surface of the day, and seismic receivers in the well. As the method evolved, the number of seismic sensors in the borehole probe increased, with the use of three-component devices. The scope of such research is very extensive. Bibliography in the oilfield review (for example https://www.slb.com/-/media/Files/resources/oilfield_review/ors03/spr03/p02_23.pdf) by Schlumberger gives only an approximate idea of the most ambitious and successful projects. At the same time, work on the creation of borehole seismic sources was also intensive [6-8]. However, their practical use was limited. For the last several decades, new principles and devices of VSP [9-10]. Theoretical and applied researches continue [11-12]. Currently, the equipment and methods of wells seismic exploration are developing to the detailed research of complex environments, the study of vertical geological boundaries (including zones of active faults), as well as increasing the efficiency and reducing the cost of geophysical operations.

Here the principal point is the possibility of controlling the power of the borehole oscillation source within wide limits, comparable with the similar characteristics of terrestrial vibrators. Equally important is the unlimited multiplicity of the elastic impacts, both for providing the mode of their accumulation and for choosing an arbitrary step of source movement along the wellbore.

High power and practically arbitrary positioning of the elastic energy generator in the well in combination with a multi-element high-sensitivity system for registering vibrations on the surface make it possible to use techniques of apertures synthesizing to ensure the directional action of seismic sources and receivers. In turn, this provides additional advantages for using the ray approximation of the process of propagation of elastic waves in the known methods of detailed study of geological media, including:
Reversing continuation of the elastic properties attributes to the lower half-space (inversion) [13-15].
Representation of a three-dimensional distribution of the elastic properties of the medium using a system of mutually intersecting rays (tomography) [16,17].
Study of structure details and the elastic characteristic distributions in the environment by the local measurement (seismolocation)—[18-21].

### SUMMARY OF THE INVENTION

The new method of seismic research vertical seismic profiling (VSP) methodology to improve the accuracy and reliability of the geological model from seismic data. The main difference between this method and existing is the use of a powerful new source of seismic waves in the wellbore, and also a two-dimensional geophones system on the surface. Also, the use specific procedures of the interferometry analysis for wave's separation and measuring the velocity dispersion of their distribution for prediction porosity, permeability and saturation (oil, gas, water) in the rocks near the wellbore.

The proposed method based on the use of hardware and equipment, which exist for seismic surveys and underground repairing of wells.

### BRIEF DESCRIPTION OF THE DRAWINGS

FIG. 1 The general scheme for implementing the wells seismic method of spatial (3D) researches.

FIG. 2. The main types of elastic vibration sources which can be used in conjunction with coiled tubing equipment.

FIG. 3. The details of the proposed scheme wells seismic researches.

FIG. 4. The scheme a directional system of the seismic vibrations emission and receiving.

FIG. 5. Comparison of standard functions of oilfield equipment and the required for the proposed seismic survey method implementation.

### DETAILED DESCRIPTION OF THE INVENTION

This section refers to the invention in more detail.

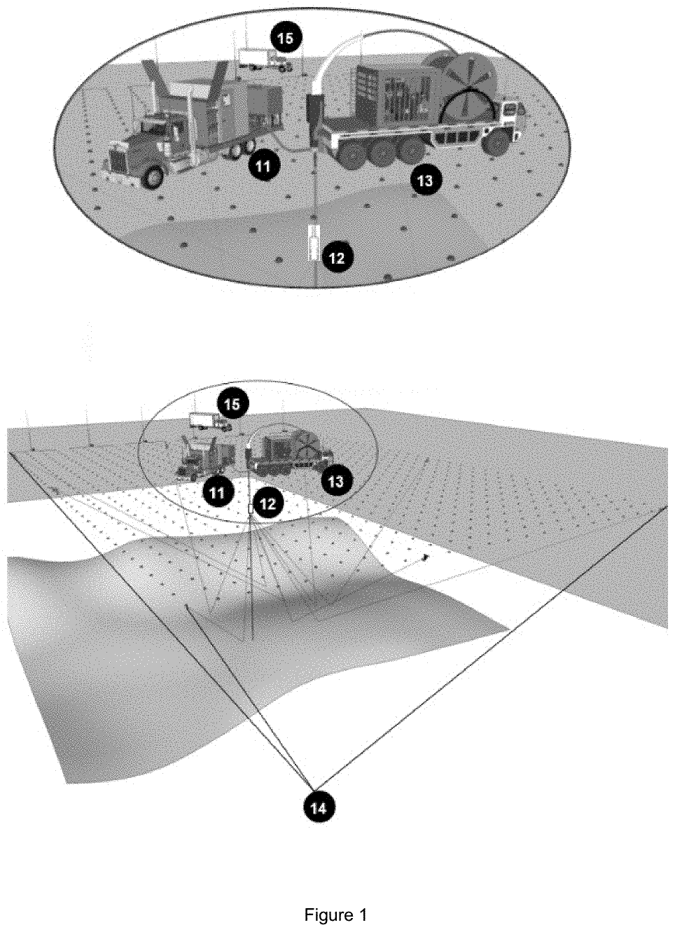

FIG. 1 shows the general scheme for implementing the method. A compressor (pumping) installation (11) is a primary source of mechanical energy, which is converted into an elastic action. Energy is transferred to the source (12) via coiled tubing equipment (13) through liquid or gas stream. In this scheme, it is possible to transfer energy sufficient to generate a high-power elastic pulse. Geophones system (14) on the day surface record the seismic signal emitted by the source from a fixed position in the wellbore. This system is commutated with a multichannel recorder—a seismic station (15) via wireline and wireless telemetry. In this case, it is possible to observe both a passing (straight) wave and waves reflected from the acoustic boundaries which are presented in the geological environment. Geophones record the seismogram from each impact position. Moving the source along the wellbore allows forming a complete database of vertical seismic profiling. There are several effective technologies for processing downhole seismic surveys data.

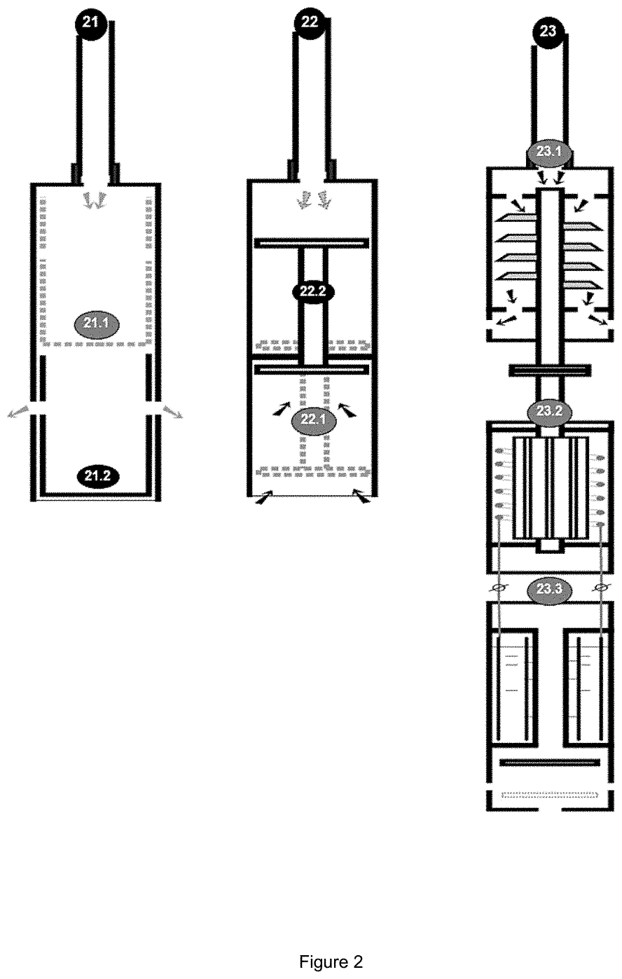

In the process of evolution of the seismic method oil and gas field exploration, numerous variants of devices for exciting seismic oscillations in wells have been developed. FIG. 2 shows the main types of such devices that can be used in conjunction with coiled tubing equipment. The pulsed pneumatic source (21) operates on the principle of a sudden release of gas under high pressure into the liquid medium. Such sources have wide practical application in marine seismic exploration and called an air gun. The gas mixture, in this case, inert nitrogen, is supplied from the surface through the coiled tubing to a closed chamber, which at a certain time is transformed from configuration 21.1 to configuration 21.2. Gas stored under high pressure enters the wellbore space, creating a shock pulse (the so-called “pulsating gas bubble effect”).

The implosion source (22) operates according to the principle of a sudden shot down of pressure in a limited working volume. This type of source can be used when it is necessary to excite elastic waves in a well at a great depth, and it is not possible to lower the level of a borehole fluid. In this case, it is difficult to use the principle of the air gun, since the pressure of the working gas mixture must repeatedly exceed the external pressure of the borehole fluid. At a depth of 1,000 feet, this pressure will be greater than 3000 kPa. At the same time, the technical characteristics of modern equipment for drilling and repair of wells with the use of coiled tubing are used to create pressure above the pressure of the borehole fluid, even at great depths. This pressure is sufficient for transformed the working zone from configuration 22.1 to configuration 22.2. Thus, executing a repetition of the elastic action on the fixed depth. The most complicated in the constructive aspect is the pulsed source of elastic oscillations which is realized by the explosion of a gas mixture of hydrogen and oxygen (the Brown gas) in a closed chamber acoustically connected to the external medium through a piston or an elastic membrane. The main limitation in the application of this type of source is the technical difficulty of passing explosive gases or high-power electric power to great depth for this gases production by electrolysis. However, modern solutions in the field of drilling on flexible pipes allow us to count on the practical possibility of constructing a downhole unit (23) as part of a downhole motor (23.1), a bottomhole electric generator (23.2), and an electrolysis cell with an explosive chamber (23.3).

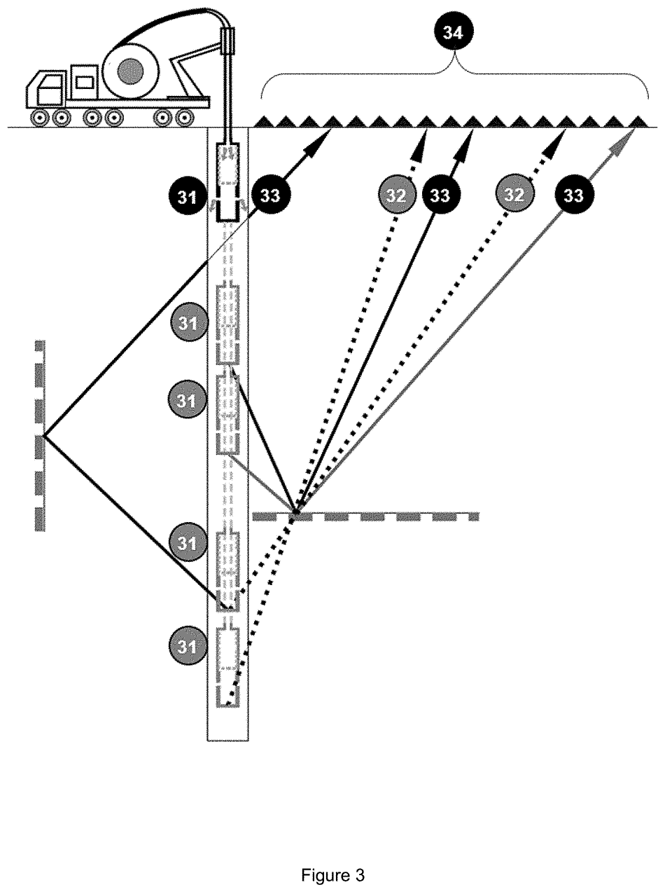

The design features of the downhole seismic sources and the corresponding technical solutions in this application are not considered since the claims are formulated as the supplying the energy for elastic impact from the surface through the coiled tubing line. Important details of the proposed method of seismic studies are refining in FIG. 3. It shows the current depth position of the oscillation source (31) in the well as well as the rays of the straight (32) and reflected (33) waves reaching the geophones (34) located on the day surface.

The location of the seismic waves source in the borehole could eliminate the influence of the upper part of the cut where high-frequency components of the seismic wave spectrum are absorbed. Kinematic and dynamic signal distortions (after the low-velocity zone) arise only in the registration phase. It significantly increases the likelihood that signal processing will compensate for distortions.

In turn, the placement of the geophones on the surface provides these advantages:
A significant increase in the number of seismic observations per area unit due to the large capacity (tens of thousands of geophones) and the mobility of modern seismic recording systems in which there are no heavy equipment and wire communication over long distances;
Increasing the detail of studies of wave polarization due to the increase in the number of independent measurements and ensuring the possibility of an accurate orientation of 3C geophones in the space.
Reduction of potential damage to the environment and industrial infrastructure due to the absence of the need to set in place and move heavy seismic vibrators in the work area.

At the same time, as in the classical VSP scheme, favorable conditions for separating and tracing waves reflected from subvertical contacts (faults, intrusions, fractured zones) continue.

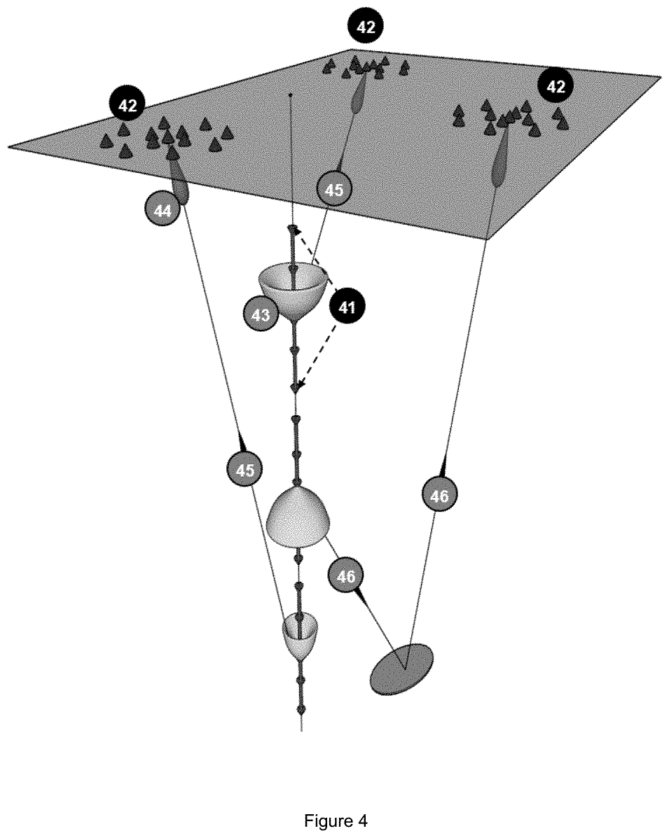

The arbitrary location of the elastic waves power source along the wellbore as well as a large number of geophones which placed on the earth surface, the potential for using interference analysis techniques in seismogram processing increases fundamentally. On FIG. 4 a general scheme of interaction between the linear group of seismic signal sources 41 and the superficial receiving group 42 has illustrated. The directivity characteristic of the linear group 43 is oriented along the conical surface, which is determined by the direction of summed wave emission relative to the source line (the well axis). The directivity characteristic of the superficial group 44 is oriented along the rising wave ray-line. The complex of a linear guided source and an area-integrated receiver of oscillations are controlling the ray-parameters of the waves at the point of excitation and the point of reception, respectively. Thus, it becomes possible to separate the observed wavefield into regular components with an independent definition of the eikonal differential characteristics for these components. It remains valid for both the direct 45 and scattered (reflected, diffracted, refracted) 46 waves systems. Enlargement of a data system by including the specified characteristics makes a more meaningful statement of tasks:
Seismic inversion by ray equation.
Seismic tomography.
Seismic side-view radar.

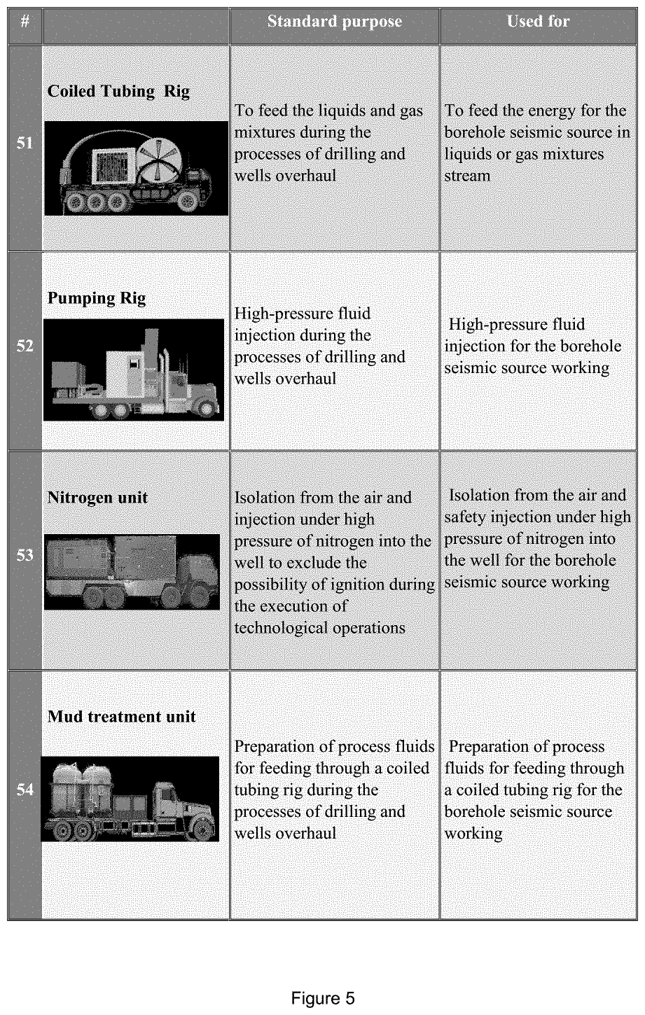

The main problem in the implementation of the proposed scheme is the transfer of enough energy to the vibration source, for a powerful elastic action. Existing equipment for drilling wells using coiled tubing allows us to overcome the main technical difficulties. FIG. 5 contains a comparison of the standard and necessary functions of such equipment. It includes Coiled Tubing Rig (51) to transfer the energy carrier to any depth into the wellbore; Pumping Rig (52) to ensure the necessary working pressure of the energy carrier; Nitrogen unit (53) to produce sufficient gas volumes inert in regard to burning or explosion; Mud treatment unit (54) to prepare and store necessary volumes of liquid used as an energy carrier.

In general, wells usually already drilled on an existing oil field. However, drilling a vertical trunk is a relatively straightforward, low-cost opration, particularly if there is no casing in place. It is thus possible to obtain a seismic, spatial “cube” of 0.25-1 square mile area in the vicinity of a given well. Observations during excitation in the well and reception by a multi-channel arrangement (5000-10,000 geophones) take up to 24 hours. The first (express) version of seismic sections can be completed in 2 days, and the entire process of processing and interpretation is completed within 2-3 weeks that fundamentally reduces the research costs.

It is expected that the use of this method will ensure the accuracy and reliability of seismic survey results much more than that of standard approach. Existing analogs Wells constructed for seismic work may then be used as a part of the subsequent mining infrastructure, after the casing montage, and after the main lower sections drilling. It reduces the risks of the project, notably the construction of the most expensive horizontal branches of the wells and application of costly inflow intensification technology (including hydraulic fracturing of the reservoir). Also, in addition to increasing the accuracy of the seismic survey results, expanding opportunities for studying massifs which are slightly differentiated in elastic waves velocity. Primarily the oil-shale formations (including artificial break zones), as well as vertical contacts in the high tectonic activity zones.

The proposed invention assumes the use of known technical solutions to provide a new methodology of downhole seismic studies. Existing equipment and tools appear in a new quality as a means of transferring energy to a well to provide the required power, mobility and stable operation of a downhole source of elastic waves.

### REFERENCES

1. B. McCollum, W. W. Larue “Utilization of existing wells in seismograph work”, Early geophysical papers, 12, 1931.
2. Gal'perin E. I. “Vertical Seismic Profiling”, Published by The Society of

Exploration Geophysicists, 1974.
3. Robert A Broding, Jr Ralph A Landrum “Fluidic oscillator seismic source”, Publication number U.S. Pat. No. 3,909,776A, Priority date Oct. 1, 1973.
4. John Blackburn, Geoffrey Hampden-Smith, Henry Menkiti, John Daniels, Scott Leaney, Joel Le Calves, Les Nutt, Adrian Sanches, Scott Dingwall, Marco Schinelli, “Borehole seismic surveys are more than just vertical profiling”, Oilfield review autumn 2007.
5. K. Müller, W. L. Soroka, S. Marmash, M. Al-Baloushi, O. Al Jeelani, B. Paulsson “How advanced processing and interpretation added value to major 3D VSP pilot studies in Abu Dhabi”, EAGE First Break, vol. 28, February 2010.
6. Chung Chang, Richard Timothy Coates, Jean G. Saint Germain “Downhole seismic source”, Publication number US20080110691 A1, Priority date Nov. 13 2006.
7. Seleznev Victor (RU), Kashun Vladimir (RU), Moskalenko Yuri (RU), Babushkin Sergey (RU) “Pneumatic source of seismic signals “Siberians”, Publication number RU 2376613, Priority date Jun. 9 2008.
8. N. Belyakov (RU) S. Pantileev (RU) “Borehole Implosive Source of Seismic Oscillations, Application number RU2009137346A, Priority date Oct. 8 2009.
9. Jun Wang “3D VSP (three-dimensional video signal processor) pre-stack imaging technology organically integrating optimization of migration aperture with avoidance of wavelet distortion”, Publication number CN102788993 A, Priority date Aug. 13, 2012.
10. Andres Chavarria, Martin Karrenbach, William Bartling “Progressive 3D Vertical Seismic Profiling Method”, Publication number US20140257707A1, Publication date Sep. 11 2014
11. Leon Liang Zie Hu “Generating subterranean imaging data based on vertical seismic profile data”, Publication number U.S. Pat. No. 9,562,983B2 Publication date Apr. 17 2014
12. Zengli Du, Jianjun Liu, Feng Xu, Yongzhang Li. “Pseudospectral reverse time migration based on wavefield decomposition”, Geophysical Journal International, 2017, 209:2, 890-900.
13. James J. Carrazzone, David Chang, Catherine Lewis, Pravin M. Shah, David Y. Wang “Method for deriving reservoir lithology and fluid content from pre-stack inversion of seismic data”, Publication number U.S. Pat. No. 5,583,825A, Priority date Sep. 2 1994.
14. Ramesh Neelamani, Partha S. Routh, Jerome R. Krebs, Anatoly Baumstein, Thomas A. Dickens, Warren S. Ross, Gopalkrishna Palacharla “Seismic data processing”, Publication number U.S. Pat. No. 9,625,593B2, Priority date Apr. 26 2011.
15. John Kenneth Washbourne, Nikhil Koolesh Shah, Kenneth Paul Bube “System and method for seismic data inversion”, Publication number US20120314538A1, Priority date Aug. 8 2011.
16. Partha Sarathi Routh, Phil D. Anno, Robert T. Baumel “Simultaneous inversion for source wavelet and AVO parameters from prestack seismic data”, Publication number U.S. Pat. No. 7,072,767B2, Priority date Apr. 1 2003.
17. Jonathan Liu “Velocity tomography using property scans”, Publication number U.S. Pat. No. 9,977,141B2, Priority date Oct. 20 2014.
18. Edgar J Ortiz “Method and apparatus for seismic exploration”, Publication number U.S. Pat. No. 5,926,437A, Priority date Apr. 8 1997.
19. G. Shaidurov, D. Kudinov, S. Paniko, M. Kopilov “On the possibilities of the seismic side-view locator with the antenna on the synthesized aperture”, Devices and systems of applied geophysics, Publisher: InformGeofizServis (Rus), ISSN: 2074-8906, Vol. 40, #2, 2012, Pages: 27-29.
20. Lei Li, Dirk Becker, Hao Chen, Xiuming Wang, Dirk Gajewski “A systematic analysis of correlation-based seismic location methods Geophysical Journal International, Volume 212, Issue 1, 1 Jan. 2018, Pages 659-678,
21. Albert J. Berni “Apparatus for remote seismic sensing of array signals using side-by-side retroreflectors” Publication number U.S. Pat. No. 5,327,216A, Priority date Sep. 18 1992.

What is claimed is:

1. A method of seismic exploration based on the excitation of elastic waves in the well, location of the geophones on the surface and using the air gun as a pulsed source of seismic signal, characterized in that with a view to expansion of regulation ranges signal's power and frequency range, the energy is supplied from the surface to the source by a flow of inert gas through the coiled tubing line.

2. A method of claim 1, characterized in that with a view to executing of seismic exploration in the wells high-pressure conditions, use the implosion source of elastic waves.

3. A method of claim 1, characterized in that with a view to achieving the widest frequency range of the seismic pulse, the energy to the source is supplied by a flow of inert liquid and as the seismic source is using the aggregate: downhole motor; electrical generator; generator of Brown gas; closed explosion chamber.

4. A method of claim 1, characterized in that for the purpose of continuous and uniform measurement of the ray-parameters of the elastic waves, the seismic oscillation sources and geophones are positioned in compliance with the synthesis conditions of the emitters local linear group in the well and the local area group of receivers on the day surface, at the stage of seismic record processing.
